(19) United States
(12) Patent Application Publication
(10) Pub. No.: US 2005/0149499 A1
(43) Pub. Date: Jul. 7, 2005

(54) Systems and methods for improving search quality

(75) Inventors: Alexander M. Franz, Palo Alto, CA (US); Monika Henzinger, Menlo Park, CA (US)

Correspondence Address: Jung-hua Kuo;Attorney At Law, PO Box 3275, Los Altos, CA, 94024, US

(73) Assignee: Google Inc., A DELAWARE CORPORATION, Mountain View, CA (US)

(21) Appl. No.: 10/749,730

(22) Filed: Dec. 30, 2003

(51) Int. Cl. G06F 7/00

(52) U.S. Cl. 707/3

(57) ABSTRACT

Systems and methods are disclosed for improving search quality. Search queries are expanded using a variety of linguistic techniques. For example, the words in a query can be supplemented with related words obtained from a database of compound words, inflectional forms, and/or orthographic variations. The expanded queries can be used to perform searches for responsive documents. A document index can be expanded using similar techniques.

### BACKGROUND OF THE INVENTION

1. Field of the Invention

The present invention relates generally to information search and retrieval. More specifically, systems and methods are disclosed for improving search quality.

2. Description of Related Art

In an information retrieval system, a user typically enters a query and receives a list of documents that contain the query terms. Documents that do not contain the query terms are ignored. Such systems thus place a premium on proper query formulation.

What is needed are systems and methods for improving queries such that they are more likely to yield useful search results.

### SUMMARY OF THE INVENTION

Systems and methods are disclosed for improving search quality. It should be appreciated that the present invention can be implemented in numerous ways, including as a process, an apparatus, a system, a device, a method, or a computer readable medium such as a computer readable storage medium or a computer network wherein program instructions are sent over optical or electronic communication lines. Several inventive embodiments of the present invention are described below.

In one embodiment, a method may generally include receiving a query containing at least one query term, making a determination whether the query includes a compound query term, a query term included in a set of inflectional forms, and/or a query term included in a set of alternative spellings, and if so, automatically expanding the query to include an alternative representations of the compound query term, a corresponding inflectional forms from the set of inflectional forms and/or a corresponding alternative spellings from the set of alternative spellings, searching a database using the expanded query, and returning results to a user.

In another embodiment, a method may generally include identifying a set of terms associated with a document, expanding the set of terms by further associating with the document one or more alternative spellings, additional inflectional forms of at least one term in the set of terms, and/or one or more alternative representations of at least one compound term in the set of terms, and indexing the document using the expanded set of terms.

In yet another embodiment, a method generally includes searching a first set of documents for hyphenated words, searching the first set of documents for non-hyphenated words that correspond to the hyphenated words, and generating a set of associations between the hyphenated and the corresponding non-hyphenated words. In one example, the method may further include receiving a query containing a first query term from a user, locating the first query term in the set of associations between hyphenated and corresponding non-hyphenated words, and expanding the query to include a second query term associated with the first query term in the set of associations between hyphenated and corresponding non-hyphenated words.

According to yet another embodiment, a computer program package embodied on a computer readable medium, the computer program package including instructions that, when executed by a processor, cause the processor to perform an action such as expanding a query received from a user by including one or more alternative spellings of at least one query term, expanding the query with one or more alternative representations of at least one compound query term, and/or expanding the query with one or more inflectional forms of at least one query term.

According to a further embodiment, an information retrieval system generally includes a document database containing a group of documents and query processing logic operable to receive a query, expand the query using one or more linguistic techniques, and search documents in the document database for information responsive to the query. The linguistic techniques may include compound term expansion, inflection set expansion, and/or orthographic expansion.

These and other features and advantages of the present invention will be presented in more detail in the following detailed description and the accompanying figures which illustrate by way of example the principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 is a diagram of an information retrieval system.

FIG. 2 is a diagram of an illustrative computing device for practicing embodiments of the present invention.

FIG. 3 illustrates a set of documents upon which a search can be performed.

FIG. 4 illustrates an index of the documents shown in FIG. 3.

FIG. 5 is a flowchart of a method for searching a group of documents such as those shown in FIG. 3.

FIG. 6A illustrates a method for generating a list of compound words.

FIG. 6B is a flowchart of a method for searching a group of documents using a list of compound words.

FIG. 7A illustrates a method for generating inflection sets for a group of words.

FIG. 7B is a flowchart of a method for searching a group of documents using inflectional information.

FIG. 8 is a flowchart of a method for searching a group of documents using orthographic information.

FIG. 9 is a flowchart of a method for searching a group of documents using one or more linguistic techniques to expand the search query.

FIG. 10 is an expanded index of the documents shown in FIG. 3.

FIG. 11 is a flowchart of a method for searching a group of documents using an index such as that shown in FIG. 10.

### DESCRIPTION OF SPECIFIC EMBODIMENTS

Systems and methods are disclosed for improving search quality. The following description is presented to enable any person skilled in the art to make and use the invention. Descriptions of specific embodiments and applications are provided only as examples and various modifications will be readily apparent to those skilled in the art. For instance, while several examples are provided in the context of a German language search engine, it will be appreciated that the general principles described herein may be applied to other languages, embodiments, and applications without departing from the spirit and scope of the invention. Similarly, although many of the examples presented below are described using Internet web pages as the documents to be searched, it is to be understood that offline documents, e.g., books, newspapers, magazines, or other paper documents that have been scanned into electronic form, may also be searched. Thus, the present invention is to be accorded the widest scope, encompassing numerous alternatives, modifications, and equivalents consistent with the principles and features disclosed herein. For purpose of clarity, details relating to technical material that is known in the fields related to the invention have not been described in detail so as not to unnecessarily obscure the present invention.

In an information retrieval system, users typically enter queries via a retrieval interface to find responsive documents. The results that are returned are generally restricted to those documents that match the query in some way. Systems and methods are described for augmenting user queries via the application of one or more linguistic techniques. In one embodiment, the user's original query is expanded using a database of compound words, inflectional forms, and/or orthographic variations. The expanded query is then used to perform a search for responsive documents.

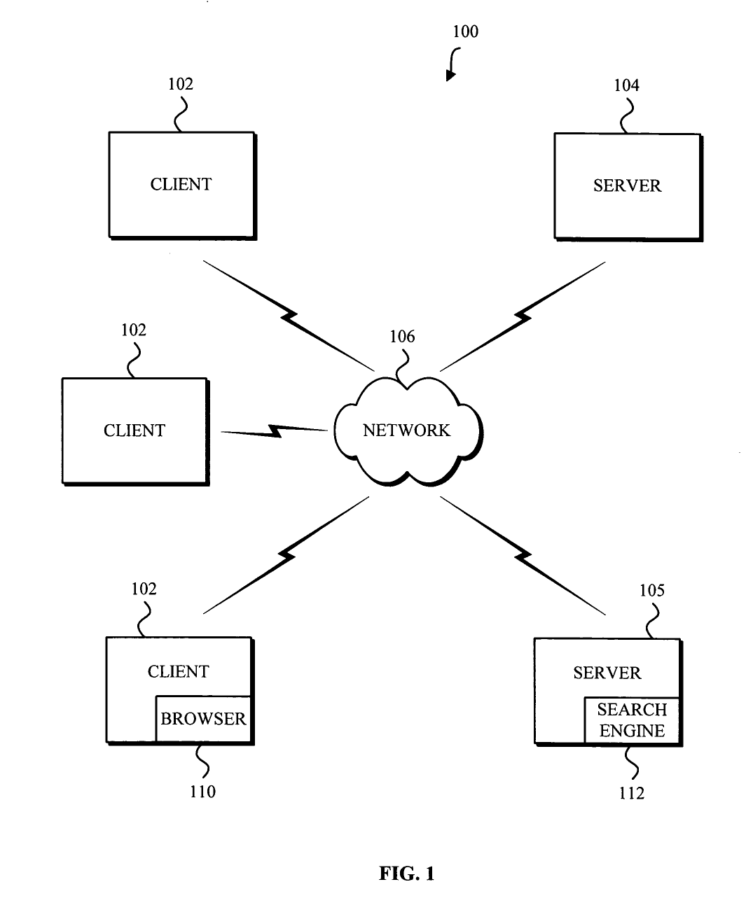

FIG. 1 illustrates a system 100 in which methods and apparatus consistent with the present invention may be implemented. The system 100 may include multiple client devices 102 connected to multiple servers 104, 105 via a network 106. Client devices 102 may include a browser 110 for accepting user input, and for displaying information that has been received from other systems 102, 104, 105 over network 106. Servers 104, 105 may include a search engine 112 for accepting user queries transmitted over network 106, searching a database of documents, and returning results to the user. The network 106 may comprise a local area network (LAN), a wide area network (WAN), a virtual private network (VPN), a telephone network, such as the Public Switched Telephone Network (PSTN), an intranet, the Internet, or a combination of networks. For the sake of illustration, FIG. 1 shows three client devices 102 and two servers 104, 105 connected to a network 106; however, it will be appreciated that in practice there may be more or less client devices, servers, and/or networks, and that some client devices may also perform the functions of a server, and some servers may perform the functions of a client.

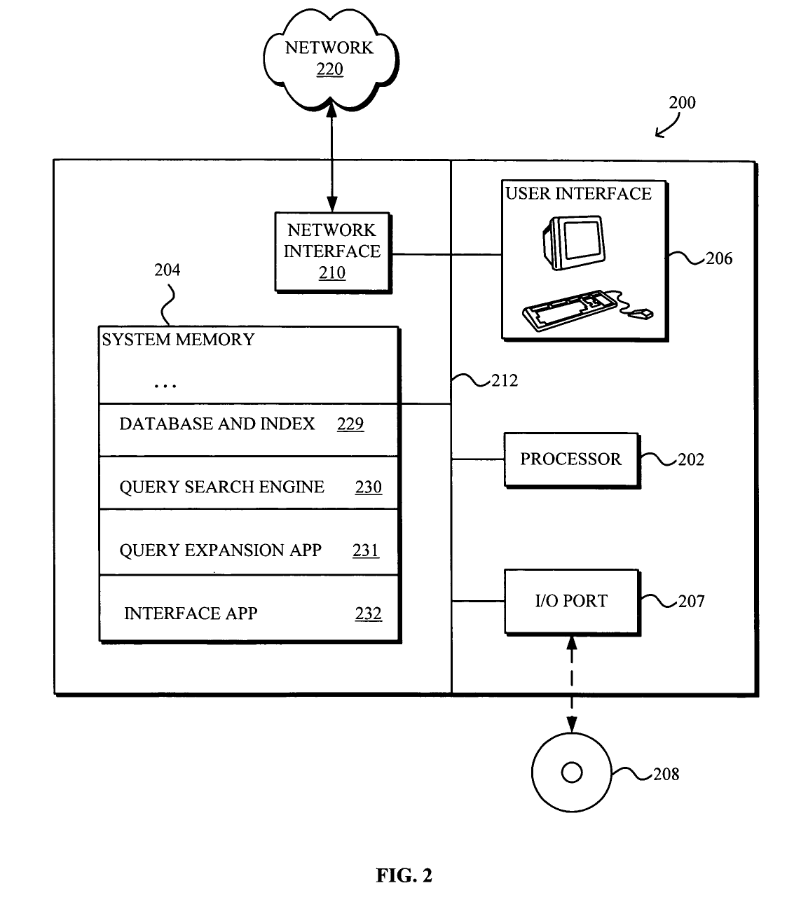

FIG. 2 shows a more detailed example a system 200, such as a client 102 or server 104, 105 shown in FIG. 1. In one embodiment, system 200 comprises a computing device such as a personal computer, laptop, mainframe, personal digital assistant, cellular telephone, and/or the like. System 200 will typically include a processor 202, memory 204, a user interface 206, an input/output port 207 for accepting removable storage media 208, a network interface 210, and a bus 212 for connecting the aforementioned elements.

The operation of system 200 will typically be controlled by processor 202 operating under the guidance of programs stored in memory 204. Memory 204 will generally include some combination of computer readable media, such as high-speed random-access memory (RAM) and non-volatile memory such as read-only memory (ROM), a magnetic disk, disk array, and/or tape array. Port 207 may comprise a disk drive or memory slot for accepting computer-readable media such as floppy diskettes, CD-ROMs, DVDs, memory cards, magnetic tapes, or the like. User interface 206 may, for example, comprise a keyboard, mouse, pen, or voice recognition mechanism for entering information, and one or more mechanisms such as a display, printer, speaker, and/or the like for presenting information to a user. Network interface 210 is typically operable to provide a connection between system 200 and other systems (and/or networks 220) via a wired, wireless, optical, and/or other connection.

As described in more detail below, system 200 may perform a variety of search and retrieval operations. These operations will typically be performed in response to processor 202 executing software instructions contained on a computer readable medium such as memory 204. The software instructions may be read into memory 204 from another computer-readable medium, such as data storage device 208, or from another device via communication interface 210 or I/O port 207. As shown in FIG. 2, memory 204 may include a variety of programs or modules for controlling the operation of system 200 and performing the search and retrieval techniques described in more detail below. For example, if system 200 is a server, such as server 105 shown in FIG. 1, memory 204 may include a database of documents 229 and a corresponding index. Memory 204 may also include a search engine 230 for searching the database 229 using a query received from user interface 206 and/or received remotely from a user over network 220. As shown in FIG. 2, memory 204 may also include one or more programs for expanding queries and/or documents using the techniques described in more detail below, and a user-interface application 232 for operating user interface 206 and/or for serving user interface web pages to remote users over network 220. Although FIG. 2 illustrates a system that is primarily software-based, it will be appreciated that in other embodiments special-purpose circuitry may be used in place of, or in combination with, software instructions to implement processes consistent with the present invention. Thus, the present invention is not limited to any specific combination of hardware and software.

It should be appreciated that the systems and methods of the present invention can be practiced with devices and/or architectures that lack some of the components shown in FIGS. 1 and 2 and/or that have other components that are not shown. Thus, it should be appreciated that FIGS. 1 and 2 are provided for purposes of illustration and not limitation as to the scope of the invention. For example, it should be appreciated that while, for purposes of illustration, system 200 is depicted as a single, general-purpose computing device such as a personal computer or a network server, in other embodiments system 200 could comprise one or more such systems operating together using distributed computing techniques. In such embodiments, some or all of the components and functionality depicted in FIG. 2 could be spread amongst multiple systems at multiple locations and/or operated by multiple parties. For example, query expansion application 231 could be implemented on a system that is separate from the system on which document database 229 is hosted (e.g., query expansion could, in some embodiments be performed on the client, rather than the server). It will be readily apparent that many similar variations could be made to the illustrations shown in FIGS. 1 and 2 without departing from the principles of the present invention.

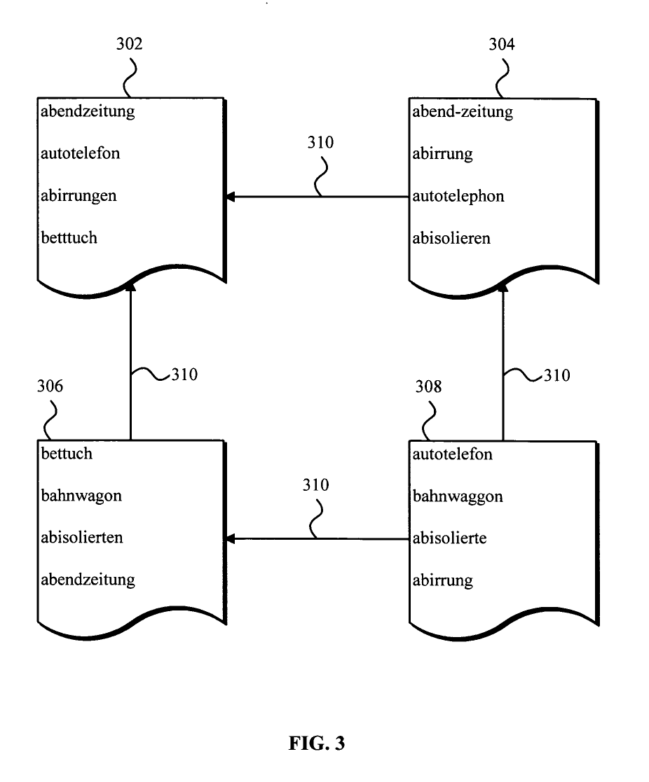

As previously indicated, the systems shown in FIGS. 1 and 2 can be used to facilitate the retrieval of documents (e.g., web pages) responsive to user queries. FIG. 3 illustrates a set of German-language documents 302, 304, 306, 308 upon which such a search can be performed. For example, documents 302, 304, 306, 308 may be stored on one or more servers 104, 105 such as those shown in FIG. 1. As shown in FIG. 3, a first document 302 contains the words “abendzeitung,” “autotelefon,” “abirrungen,” and “betttuch.” A second document 304 contains the words “abend-zeitung,” “abirrung,” “autotelephon,” and “abisolieren.” A third document 306 contains the words “bettuch,” “bahnwagon,” “abisolierten,” and “abendzeitung.” And a fourth document 308 contains the words “autotelefon,” “bahnwaggon,” “abisolierte,” and “abirrung.” Documents 302, 304, 306, 308 may also include one or more links (or references) 310 to other documents. Although, for the sake of illustration, FIG. 3 shows documents written in German, it will be appreciated that the documents could be written in any language or combination of languages.

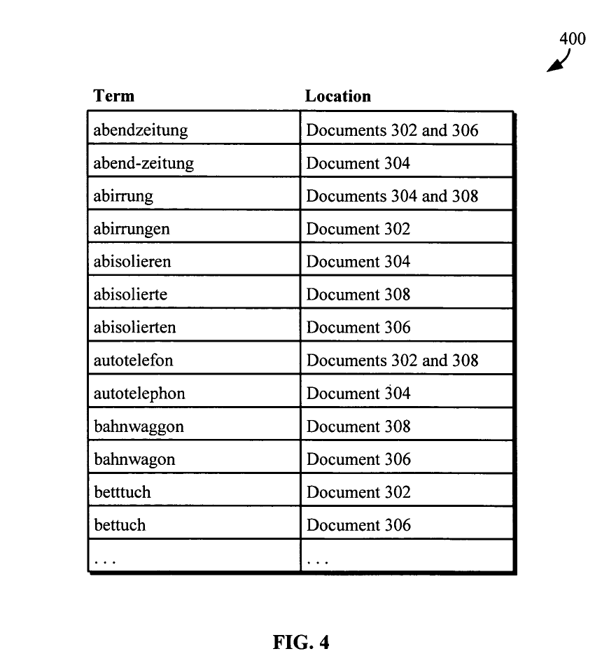

FIG. 4 illustrates an index 400 based on the documents shown in FIG. 3. The first column of the index contains a list of terms, and the second column contains a list of documents corresponding to those terms. Some terms, such as “bahnwaggon,” only correspond to (e.g., appear in) one document (i.e., document 308). Other terms, such as “autotelefon,” correspond to multiple documents (i.e., documents 302 and 308).

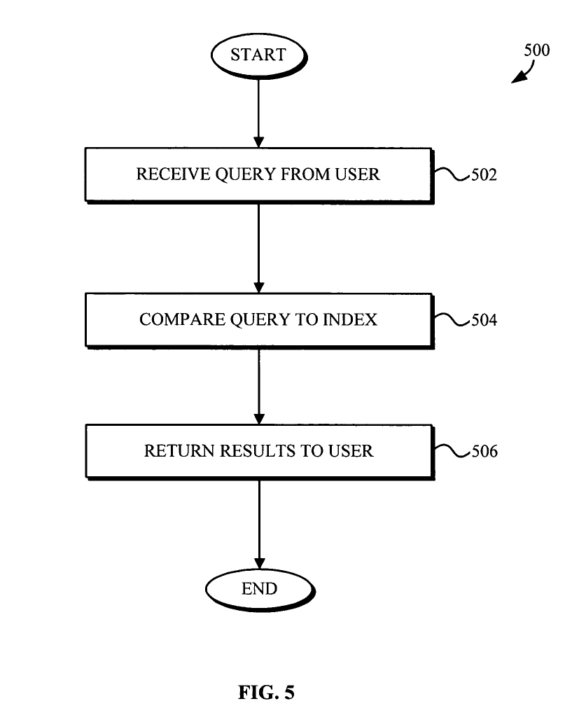

FIG. 5 illustrates a process 500 by which a search engine, such as search engine 112 in FIG. 1, might use the index 400 illustrated in FIG. 4 to provide search results in response to a query. Search engine 112 receives a query (block 502), and uses an index, such as index 400, to determine which documents correspond to that query (block 504). For example, boolean logic can be used to match the query with the documents, or a term frequency-inverse document frequency (tf-idf) based information retrieval score could be used, with the words in the query combined with the words in each document. Thus, for example, if the query were “abendzeitung,” search engine 112 could use index 400 to determine that “abendzeitung” appears in documents 302 and 306. These documents, and/or a reference thereto, are then returned to the user (block 506).

As seen in the foregoing example, a search may fail to identify documents that do not contain the exact query terms. For instance, in the example described in connection with FIG. 5, the query “abendzeitung” failed to locate document 304, which contains the term “abend-zeitung.”

One way to improve search results is to expand queries to include possible variants of the query terms, thereby ensuring that responsive documents that contain these variants are not missed. In a preferred embodiment, a variety of linguistic features such as compound words, inflections, and orthographic (e.g., spelling) variations are used for this purpose.

Compounds

In many languages, certain word pairs can be written separately, written as compounds, or hyphenated. For example, in the German language many nouns can be concatenated to form longer nominal compounds. In many cases, there is not a standard way to write these words (e.g., concatenated, hyphenated, or separated), and thus different forms may be used in different documents. For example, the term “fernsehprogramm” (meaning television program) can be written either as “fernsehprogramm” or “fernseh-programm.” Thus, a query that uses one form of this word, but not the other, may fail to locate responsive documents.

In one embodiment, this problem can be solved or ameliorated by generating a list of potential compound words, then using this list to expand queries containing one or more compound words from the list. The list of word pairs (or triplets, etc.) can be generated in a variety of ways. For example, it could be formed using a dictionary, or by dynamically searching across a corpus of documents (e.g., Internet web pages) and generating a list of compound terms.

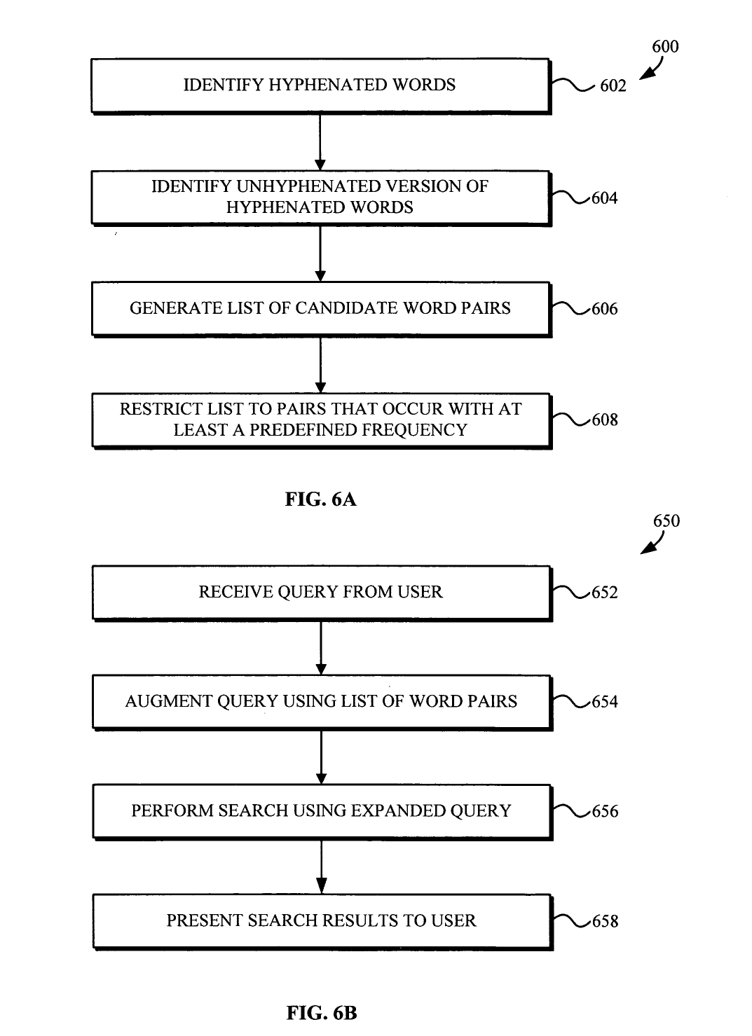

FIG. 6A shows an example of such a method 600. As shown in FIG. 6A, a list of potential word pairs is generated by searching a set of documents for hyphenated words (block 602), then searching the documents for the corresponding unhyphenated version of each word (block 604). A list can then be generated of each word pair (e.g., “AB or A-B”) that was identified (block 606). In some embodiments, the resulting list may then be shortened by, e.g., removing word pairs that occur with a relatively low frequency in the set of documents (block 608). For example, an examination could be made of the number of times that “AB” appears in the corpus, the number of times that “A-B” appears, and/or the like. It will be appreciated that a number of variations can be made to the basic process shown in FIG. 6A. For example, in some embodiments the set of documents could also be searched for instances in which “compound” words appear as pairs (or triplets, etc.) of separate, unhyphenated words (e.g., “A B”).

As shown in FIG. 6B, the resulting list of compound words can then be used to expand queries that contain one or more of the words on the list. For example, when a query is received (block 652), it can be examined to determine if it contains any words in the list of word pairs. If the query contains a word that is part of a compound pair, the query can be supplemented to include the other part of the pair (block 654). For example, the word can be replaced by a disjunction of both forms of the word. For example, “AB” could be replaced by “AB OR A-B”; “A-B” could be replaced by “A-B OR AB”; and so forth. Thus, for example, the query “abendzeitung,” discussed above in connection with FIG. 5, would be expanded to “abendzeitung OR abend-zeitung,” and would yield documents 302, 304, and 306 (rather than just documents 302 and 306) when compared with the index.

In some embodiments, the list of compound words described above can be used to improve search results in other ways as well. For example, documents written in formats such as Postscript (PS) or Adobe's Portable Document Format (PDF) often include hyphenation to break words at the end of lines. These words may be indexed improperly as hyphenated words. Thus, in one embodiment the list of compound words described above can be used at document indexing (or parsing) time. When a hyphenated word is encountered, it is compared to the list of compound words, and if it is not located, the hyphen can be removed when the word is indexed.

Inflections

Similarly, many words have a variety of inflectional forms for expressing grammatical relationships such as case, gender, number, person, tense, or mood. Examples of English inflections include the addition of “s” to a noun to form a plural, or the addition of “ed” to a verb to express the past tense. Other inflections involve changing the base word itself, as illustrated by the inflection set “speak,” “spoke,” and “spoken.”

German has a wide variety of inflectional forms as well. For example, “abirrung” and “abirrungen” are different inflectional forms of the same root, as are “spiel,” “spiele,” “spielen,” “spieles,” and “spiels.” Thus, a query that uses one inflectional form, but not the others, may fail to identify documents that would be of interest to the user who generated the query.

Thus, in one embodiment sets of inflectional forms are assembled, and then used to expand queries. The inflection sets can be obtained in a variety of ways, such as by consulting a dictionary or by using an automated tool. For example, if German is the query language, the inflection sets could be generated using a language analysis or generation tool with a relatively large lexicon of root forms, such as with any suitable word form analyzer.

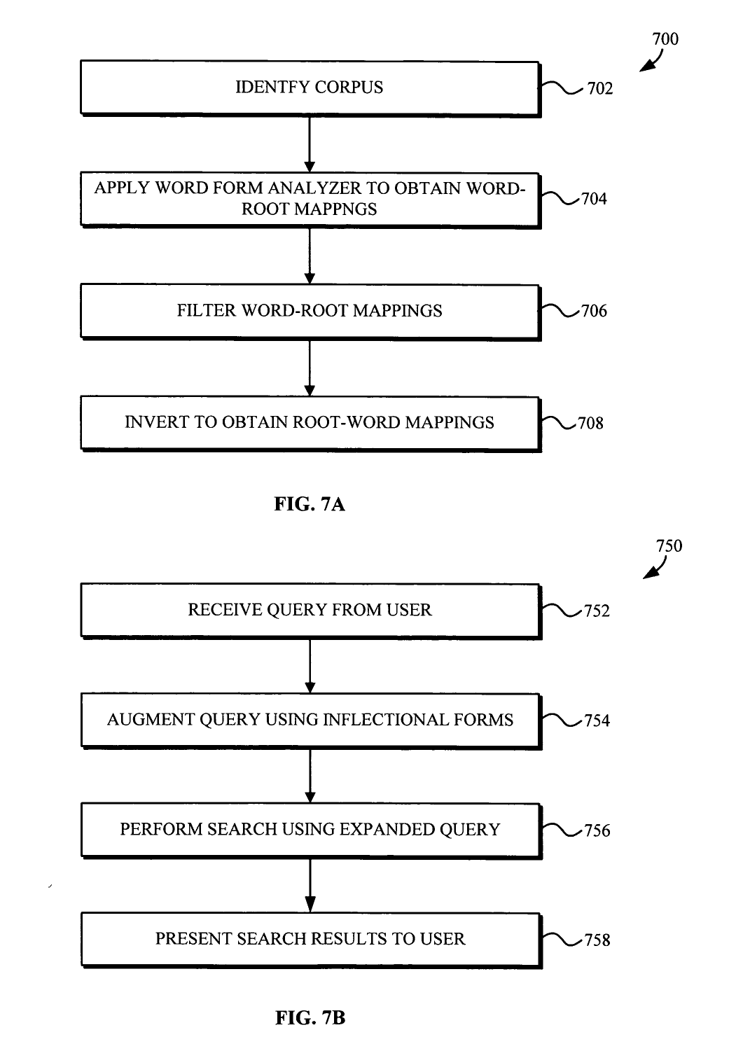

As shown in FIG. 7A, in one embodiment a set of inflectional forms can be created by collecting a set of words from a corpus of documents (e.g., web pages) (block 702). A word form analyzer can then be applied to this set of words, yielding a set of mappings between inflected words and roots (block 704). In some embodiments, the set of mappings can be filtered by using only those words that appear in some suitable number or percentage of the documents (e.g., those words that appear in at least 100 documents) (block 706). The table can then be inverted, resulting in a set of mappings between roots and inflected forms (block 708).

FIG. 7B shows a method for performing query expansion using inflection sets generated using a method such as that shown in FIG. 7A. As shown in FIG. 7B, if a query contains a word that is a member of an inflection set (block 752), the query is augmented by including the disjunction of all the members in the inflection set (or some suitable subset) (block 754). For example, the query “auto spiel” could become “(auto OR autos) (spiel OR spiele OR spiel OR spiele OR spielen OR spieles OR spiels).” The expanded query is then used to perform a search of the document database (e.g., by comparing the search with an index of the database) (block 756), and the results of the search are presented to the user (block 758). Thus, for example, if a user submitted a query containing the word “abisolieren,” this could be expanded to “abisolieren OR abisolierten OR abisolierte,” thereby enabling a search of the documents shown in FIG. 3 to identify documents 306 and 308 in addition to document 304.

It will be appreciated that a number of variations can be made to the basic concepts illustrated in FIGS. 7A and 7B. For example, other variants of the root forms of the query terms could be included in the expansion, regardless of whether those variants were, strictly speaking, inflections of the query terms. As another example, in some embodiments the inflection sets used to perform the query expansion could be generated by consulting a dictionary or other source, rather than applying a word form analyzer in the manner described in connection with FIG. 7A.

Orthographic Variations

Many languages include a number of words that can be spelled in different ways. For example, many German words have different spellings due to dialectical variations and/or the recent spelling reform. Examples of common German spelling variations include the interchangeability of “ph” and “f” (e.g., “telefon” or “telephon”), “β” and “ss” (e.g., “maβe” or “masse”), the interchangeability of various repeat letter sequences (e.g., “wagon” or “waggon,” “bettuch” or “betttuch,” etc.), and the use of apostrophes (e.g., “kantsch” or “kant'sch”).

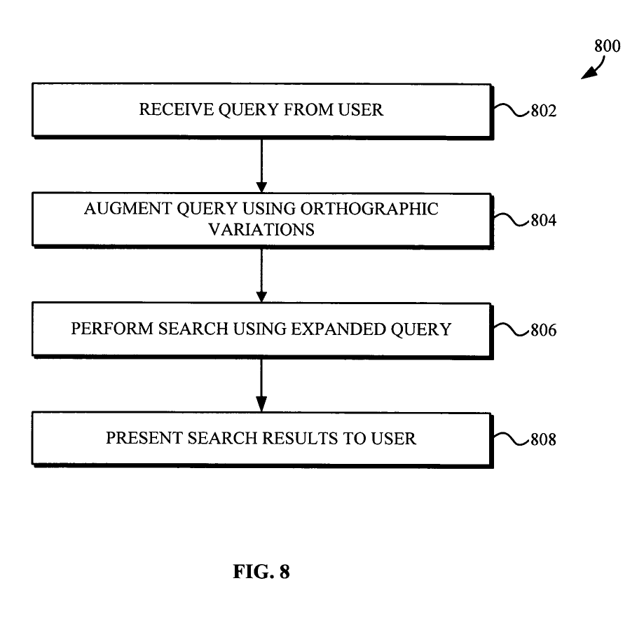

Thus, in one embodiment a table is created of orthographic variations. This can be accomplished, e.g., by consulting a dictionary or other source. For example, many of the variations in German spelling can be obtained by examining data relating to the German spelling reform (e.g., using any suitable word form analyzer), and/or the like. As an example, information on the German spelling reform is provided by Institut fuer Deutsche Sprache (Institute for the German Language) at http://www.ids-mannheim.de/org/, a foundation that has published extensive information about the German language. As shown in FIG. 8, this table can be used to expand user queries (blocks 802-804), which can then be used to search for responsive documents (blocks 806-808).

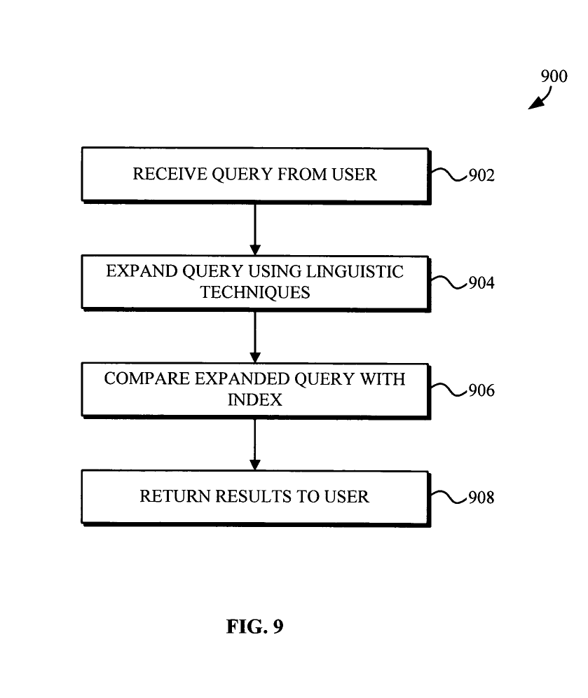

Thus a variety of techniques have been described for improving search results. It will be appreciated that these techniques can be applied individually, or in combination with each other and/or with other techniques. FIG. 9 illustrates the general process of applying linguistic techniques such as those described above to perform searches on an index or database of documents. As shown in FIG. 9, when a query is received from a user (block 902), it is expanded through application of one or more of the techniques described above (block 904). The expanded query is then compared to a database index to locate responsive documents (block 906), which are then returned or identified to the user (block 908).

It will be appreciated that a variety of changes can be made to the systems and methods described above in accordance with embodiments of the present invention. For example, the techniques described above can be applied in combination with other techniques, such as spelling correction, synonym and/or related-word expansion, language translation, spam reduction, and/or the like, to further enhance search results. As another example, in some embodiments multiple searches could be performed in response to a user's query. For example, a search could first be performed using the user's original query, followed by one or more searches using expanded or re-written versions of that query. The results of these searches could be evaluated (e.g., using information regarding the user's preferences and search history), and the results determined to be most likely to be useful could be returned. For example, the highest quality results from the original query could be supplemented with results from the expanded query if those results were determined to be of higher or comparable quality. Alternatively, or in addition, the terms in the expanded query could be weighted differently. For example, a higher weighting could be assigned to the original query terms, and lower weightings could be assigned to the terms added via expansion.

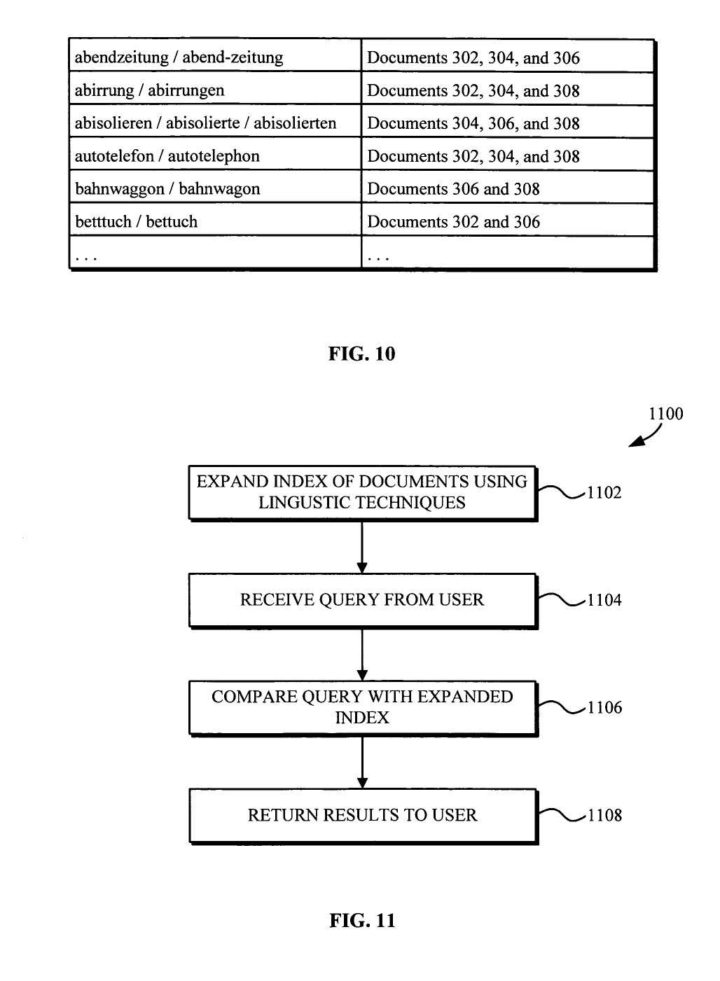

In addition, although the examples described above involve expansion of the user's query, in other embodiments the document index itself can be expanded instead (or in addition). FIG. 10 shows an example of such an expanded index for the documents shown in FIG. 3. As shown in FIG. 10, the various compound terms, inflection sets, and orthographic variations are grouped together in the left-hand column of the index, and the documents that contain any term in the group are listed in the right-hand column. As shown in FIG. 11, once the expanded index is generated (block 1102), user queries (block 1104) can be compared directly with the index (block 1106) without performing query expansion. Alternatively, some combination of index expansion and query expansion could be used.

Moreover, while many of the examples provided above have been in the context of the German language, it will be appreciated that the techniques that have been described are readily applicable to other languages as well. Each language has its own set of linguistic features that pose problems for search. Thus, to design a search engine for a given language, and/or a general-purpose search engine, an effort can be made to identify these problems and to address them. For example, random searches can be performed to see what search terms cause problems. The search terms can then be varied to see if improvements can be made. User sessions can also be analyzed to find patterns in users' searching behavior. For example, users may apply certain transformations to compensate for problematic aspects of the language. Once a set of problem areas are identified, work can be done to generate solutions. Potential solutions can be tested or simulated to determine their effectiveness and the amount of effort needed to implement them.

While the preferred embodiments of the present invention are described and illustrated herein, it will be appreciated that they are merely illustrative and that modifications can be made to these embodiments without departing from the spirit and scope of the invention. Thus, the invention is intended to be defined only in terms of the following claims.

1. A method comprising:
receiving a query containing at least one query term;
performing at least one of:
(A) determining whether the query includes one or more compound query terms, and if so, automatically expanding the query to include one or more alternative representations of said one or more compound query terms;
(B) determining whether one or more query terms are included in a set of inflectional forms, and if so, automatically expanding the query to include one or more corresponding inflectional forms from the set of inflectional forms; and
(C) determining whether one or more query terms are included in a set of alternative spellings, and if so, automatically expanding the query to include one or more corresponding alternative spellings from the set of alternative spellings;
searching a database using the expanded query; and
returning results to a user.

2. The method of claim 1, in which the method includes determining whether the query includes one or more compound query terms, and if so, automatically expanding the query to include one or more alternative representations of said one or more compound query terms.

3. The method of claim 1, in which the method includes determining whether one or more query terms are included in a set of inflectional forms, and if so, automatically expanding the query to include one or more corresponding inflectional forms from the set of inflectional forms.

4. The method of claim 1, in which the method includes determining whether one or more query terms are included in a set of alternative spellings, and if so, automatically expanding the query to include one or more corresponding alternative spellings from the set of alternative spellings.

5. The method of claim 4, in which the method further includes performing (B) and in which automatically expanding the query to include one or more corresponding alternative spellings from the set of alternative spellings is performed before automatically expanding the query to include one or more corresponding inflectional forms from the set of inflectional forms.

6. The method of claim 1, in which the method includes performing at least two of said (A), (B), and (C).

7. The method of claim 1, in which determining whether the query includes one or more compound query terms includes comparing a query term to a list of compound terms.

8. The method of claim 7, in which said one or more alternative representations of said one or more compound query terms are obtained from the list of compound terms.

9. The method of claim 1, in which the query is written in German.

10. The method of claim 1, in which the actions are performed in the order recited.

11. A method comprising:
identifying a set of terms associated with a document;
expanding the set of terms associated with the document by further associating with the document one or more of the following:
one or more alternative spellings of at least one term in the set of terms associated with the document;
one or more alternative representations of at least one compound term in the set of terms associated with the document; and
one or more additional inflectional forms of at least one term in the set of terms associated with the document;
indexing the document using the expanded set of terms.

12. The method of claim 11, further comprising:
receiving a query from a user, the query containing one or more of the alternative spellings, alternative representations, or additional inflectional forms; and
identifying the document to the user as being responsive to the query.

13. The method of claim 11, in which the document comprises a web page.

14. A method comprising:
searching a first set of documents for hyphenated words;
searching the first set of documents for non-hyphenated words that correspond to said hyphenated words; and
generating a set of associations between said hyphenated words and said corresponding non-hyphenated words.

15. The method of claim 14, further comprising:
searching the first set of documents for pairs of separate words that correspond to the non-hyphenated words and corresponding hyphenated words;
further associating the pairs of separate words with the set of associations between said hyphenated words and said corresponding non-hyphenated words.

16. The method of claim 14, further comprising:
receiving a query from a user, the query containing a first query term;
locating the first query term in the set of associations between hyphenated words and corresponding non-hyphenated words; and
expanding the query to include a second query term, the second query term being associated with the first query term in the set of associations between hyphenated words and corresponding non-hyphenated words.

17. The method of claim 16, further comprising:
performing a search using the expanded query;
sending the user a list of one or more documents responsive to the query.

18. The method of claim 14, further comprising:
locating a hyphenated word in a document;
searching for the hyphenated word in the set of associations between hyphenated words and corresponding non-hyphenated words;
if the hyphenated word is not found in the set of associations between hyphenated words and corresponding non-hyphenated words, de-hyphenating the hyphenated word; and
indexing the document using the de-hyphenated word.

19. A computer program package embodied on a computer readable medium, the computer program package including instructions that, when executed by a processor, cause the processor to perform an action selected from the group consisting of:
expanding a query received from a user by including one or more alternative spellings of at least one query term;
expanding the query with one or more alternative representations of at least one compound query term; and
expanding the query with one or more inflectional forms of at least one query term.

20. The computer program package of claim 19, further including instructions that, when executed by a processor, cause the processor to perform actions comprising:
searching a database of documents using the expanded query;
identifying one or more documents responsive to the expanded query; and
preparing a list of said one or more documents for transmission to the user.

21. The computer program package of claim 19, further including instructions that, when executed by a processor, cause the processor to perform actions comprising:
sending the expanded query to another computer system; and
receiving from the other computer system a list of one or more documents responsive to the expanded query.

22. An information retrieval system, the system comprising:
a document database, the document database containing a group of documents; and
query processing logic operable to receive a query, expand the query using one or more linguistic techniques, and search documents in the document database for information responsive to the query.

23. The system of claim 22, in which the one or more linguistic techniques comprise one or more of compound term expansion, inflection set expansion, or orthographic expansion.
